(19) United States
(12) Patent Application Publication
(10) Pub. No.: US 2016/0273167 A1
(43) Pub. Date: Sep. 22, 2016

(54) Dialdehyde Modified Acrylamide Type Polymer and Method for Preparing Same

(71) Applicant: ECOLAB USA INC., St. Paul, MN (US)

(72) Inventors: Meng Zhang, Shanghai (CN); Bo Zhu, Shenyang (CN); Yulin Zhao, Shanghai (CN); Jian Kun Shen, Shanghai (CN); Na Xu, Shanghai (CN)

(73) Assignee: Ecolab USA Inc., St. Paul, MN (US)

(21) Appl. No.: 15/033,351

(22) PCT Filed: Oct. 13, 2014
(86) PCT No.: PCT/US2014/060305

§ 371 Date: May 4, 2016

(30) Foreign Application Priority Data
Oct. 31, 2013 (CN) 201310530004.6

(51) Int. Cl. D21H 21/20; D21H 17/37; C08F 8/00

(52) U.S. Cl. CPC D21H 21/20; C08F 8/00; D21H 17/375

(57) ABSTRACT

The invention provides a dialdehyde modified acrylamide type polymer for paper making, which is obtained by reacting a dialdehyde with an acrylamide type base polymer, wherein the acrylamide type base polymer is formed by copolymerization of an acrylamide type monomer, a cationic monomer and/or an anionic monomer and a cross linking agent. The invention further provides a method for preparing said dialdehyde modified acrylamide type polymer. The dialdehyde modified acrylamide type polymer according to the invention has improved stability while maintains excellent enhanced performance.

### TECHNICAL FIELD OF THE INVENTION

The invention relates to a dialdehyde modified acrylamide type polymer used in the paper making process and a method for preparing the same.

### BACKGROUND OF THE INVENTION

Chemical adjuvants for paper making have played important roles in the sustainable development of the paper making industry and receive wide attention. Glyoxylated polyacrylamide copolymers (glyoxylated polyacrylamides GPAMs), as effective paper strengthening agents and dehydrating agents, have been used in the manufacture of various paper (see, e.g., U.S. Pat. No. 3,556,932A, U.S. Pat. No. 4,605,702A, etc.). However, the glyoxylated polyacrylamide copolymer products currently available in the market have poor stability and short shelf lives, which causes inconvenience in use.

Currently, several methods and strategies have been raised for the improvement of the stability of current glyoxylated polyacrylamide copolymers. However, no desirable effect has been achieved.

For example, in US2008/0308242A1, the stability of the product was improved by increasing the amount of cationic monomers in the glycoxalated polyacrylamide copolymer to at least 25 mol %. However, results from the ring crush test of the paper made indicated that the polymer products thus obtained did not have sufficient strength. That is to say, the strengthening effect of the product is limited.

Therefore, an improved GPAM product needs to be provided which, while retaining the functions of the commercial available products, also has improved stability. This problem is solved by the dialdehyde modified acrylamide type polymer of the invention. This polymer also has excellent stability and excellent strengthening performance.

### SUMMARY OF THE INVENTION

During research, the inventor has surprisingly found that the following dialdehyde modified acrylamide type polymer is able to have improved stability while having excellent strengthening performance:

a dialdehyde modified acrylamide type polymer for paper making, which is obtained by reacting a dialdehyde with an acrylamide type base polymer, wherein the acrylamide type base polymer is formed by copolymerization of an acrylamide type monomer, a cationic monomer and/or an anionic monomer, as well as a cross linking agent,

wherein the total amount of the cationic monomer and anionic monomer is more than 9 mol % and up to 50 mol %, for example, 10 mol % to less than 25 mol % of the base polymer, and

wherein the cross linking agent is a monomer having at least two unsaturated double bonds, for example, a monomer having at least two vinyls.

The invention further provides a method for preparing the aforesaid dialdehyde modified acrylamide type polymer, use thereof, and a corresponding paper product.

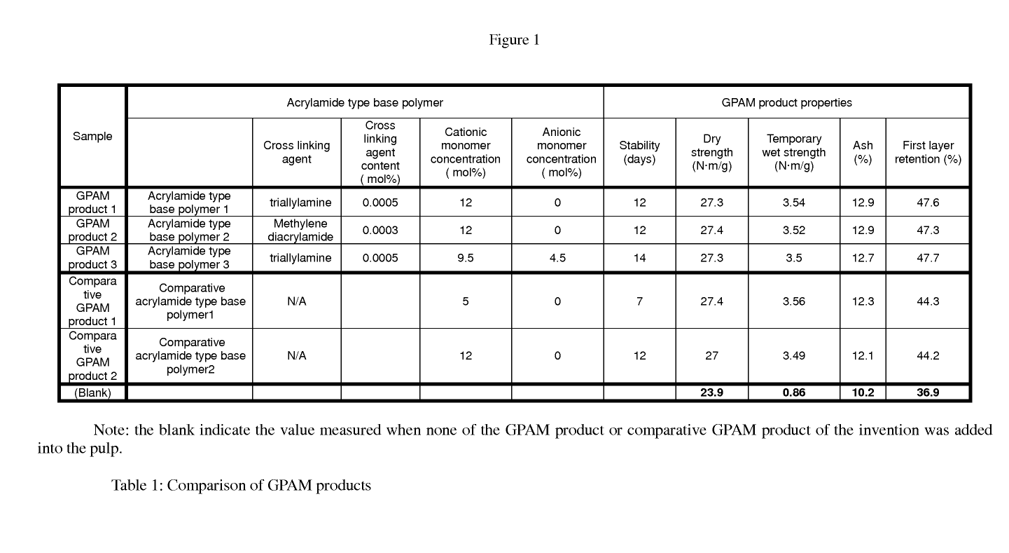

FIG. 1 is a table including the results of comparing GPAM products according to the example.

### DETAILED DESCRIPTION

In order to make the object, technical solutions and advantages of the embodiments of the invention more clear, the technical solutions of the embodiments of the present invention are clearly and completely described below in relation to the Figures of the embodiments of the present invention. Apparently, the embodiments described are merely some, rather than all embodiments of the present invention.

The dialdehyde modified acrylamide type polymer according to the invention is obtained by reacting a dialdehyde with an acrylamide type base polymer, wherein the acrylamide type base polymer is formed by copolymerization of an acrylamide type monomer, a cationic monomer and/or an anionic monomer, as well as a cross linking agent,

wherein the total amount of the cationic monomer and anionic monomer is more than 9 mol % and up to 50 mol %, for example, 10 mol % to less than 25 mol % of the base polymer, and

wherein the cross linking agent is a monomer having at least two unsaturated double bonds, for example, at least two vinyls.

Generally, the dialdehyde modified acrylamide type polymer according to the invention can be prepared by the following two steps:

(a) an acrylamide type monomer, a cationic monomer and/or and anionic monomer, and a cross linking agent are copolymerized to form a acrylamide type base polymer;

(b) the acrylamide type base polymer thus obtained is reacted with a dialdehyde,

thereby providing the dialdehyde modified acrylamide type polymer of the invention.

Below, the various steps and the materials and relevant reactions used in them are introduced in details.

According to the invention, in step (a), an acrylamide type monomer, a cationic monomer and/or an anionic monomer, as well as a cross linking agent co-polymerize to form an acrylamide type base polymer.

Acrylamide Type Monomer

An acrylamide type monomer is a basic building block of the dialdehyde modified acrylamide type polymer. The term “acrylamide type monomer” used herein usually indicates the monomer of the following formula:

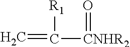

wherein R₁ is H or C₁-C₄ alkyl, and R₂ is H, C₁-C₄ alkyl, aryl or arylalkyl.

The term “alkyl” used herein means a monovalent group derived from a straight or branched chain saturated hydrocarbon by the removal of a single hydrogen atom. Representative alkyl groups include methyl, ethyl, n- and iso-propyl, cetyl, and the like. C₁-C₄ alkyl indicates an alkyl with a carbon number of 1 to 4, for example, methyl, ethyl, n-propyl, iso-propyl, and the like.

The term “alkylene” used herein means a divalent group derived from a straight or branched chain saturated hydrocarbon by the removal of two hydrogen atoms. Representative alkylene groups include methylene, ethylene, propylene, and the like.

The term “aryl” used herein means an aromatic monocyclic or multicyclic ring system of about 6 to about 10 carbon atoms. The aryl is optionally substituted with one or more C₁-C₂₀ alkyl, alkoxy or haloalkyl groups. Representative aryl groups include phenyl or naphthyl, or substituted phenyl or substituted naphthyl, wherein the substituent in the substituted phenyl or substituted naphthyl may be an alkyl.

The term “alkoxyl” used herein is understood as an “alkyl-O-” group, herein the “alkyl” is defined as above.

The term “halogen” or “halo” used herein includes fluoro-, chloro-, bromo-, and iodo-.

The term “arylalkyl” used herein means an aryl-alkylene-group where aryl and alkylene are defined herein. Representative arylalkyl groups include benzyl, phenylethyl, phenylpropyl, 1-naphthylmethyl, and the like, e.g., benzyl.

Examples of the acrylamide type monomer used herein include but are not limited to: acrylamide, methacrylamide, N-substituted acrylamide, N,N-disubstituted acrylamide, and the like. In the N-substituted acrylamide and N,N-disubstituted acrylamide, the substituent may be an alkyl, wherein the definition of the alkyl is as mentioned above. Their specific examples include but are not limited to N-isopropylacrylamide, N,N-dimethylacrylamide, N,N-ethylacrylamide, and the like.

In said acrylamide type base polymer, more than one acrylamide type monomer may be present (for example, two, three, or more). For example, acrylamide and methacrylamide may be used together as the acrylamide type monomer in the copolymerization.

In some embodiments, acrylamide or methacrylamide is used as the acrylamide type monomer.

In some specific embodiments, acrylamide is used as the acrylamide type monomer.

It should be understood that when the acrylamide type base polymer is formed by the copolymerization of an acrylamide type monomer, a cationic monomer and a cross linking agent, said acrylamide type base polymer is cationic;

when the acrylamide type base polymer is formed by the copolymerization of an acrylamide type monomer, an anionic monomer and a cross linking agent, said acrylamide type base polymer is anionic; and

when the acrylamide type base polymer is formed by the copolymerization of an acrylamide type monomer, a cationic monomer, an anionic monomer and a cross linking agent, said acrylamide type base polymer is amphoteric.

Cationic Monomer

A cationic monomer will be used herein in circumstances of forming a cationic or amphoteric acrylamide type base polymer by copolymerization. In the invention, the cationic monomer may be an unsaturated monomer comprising an amino and/or quarternary ammonium group.

The term “amino” used herein means a group with the formula —NHY₂, wherein Y₂ is selected from H, alkyl, aryl and aralkyl. Wherein the definitions of “alkyl”, “aryl” and “aralkyl” are the same as the ones provided above.

Examples of the cationic monomers suitable for the invention include but are not limited to: diallyl-N,N-disubstituted ammonium chloride monomer (wherein substituent is for example methyl, ethyl or propyl), diallyldimethylammonium chloride (DADMAC), N-(3-dimethylaminopropyl)methacrylamide, N-(3-dimethylaminopropyl)acrylamide, methylacroloyloxyethyltrimethylammonium chloride (DMAEM-MCQ), acroloyloxyethyltrimethylammonium chloride (DMAEA-MCQ), methylacroloyloxyethyldimethylbenzylammonium chloride, acroloyloxyethyldimethylbenzylammonium chloride, (3-acrylamidepropyl)trimethylammonium chloride, methacrylamidepropyltrimethylammonium chloride, 3-acrylamido-3-methylbutyltrimethylammonium chloride, 2-vinylpyridine, methacrylate-2-(dimethylamino) ethyl ester, acrylate 2-(dimethylamino) ethyl ester and glycol acrylate, or combinations of two or more thereof. That is to say, in the acrylamide type base polymer, if a cationic monomer is present, more than one (for example, two, three, or more) cationic monomer may be present based on need.

In some specific embodiments, used as the cationic monomer is diallyldimethylammonium chloride (DADMAC), methylacroloyloxyethyltrimethylammonium chloride (DMAEM-MCQ) or acroloyloxyethyltrimethylammonium chloride (DMAEA-MCQ).

In a more specific embodiment, used as the cationic monomer is diallyldimethylammonium chloride (DADMAC).

Generally, if a cationic monomer is present, i.e. in the cases of an amphoteric or cationic acrylamide type base polymer, the amount of said cationic monomer may be at least 5 mol %, for example, at least 8 mol %, also for example, at least 10 mol % of the base polymer.

In particular, in the case of a cationic acrylamide type base polymer, the typical amount of the cationic monomer is at least 10 mol % of the base polymer. Usually, the amount of the cationic monomer does not exceed 50 mol %, conveniently 25 mol % of the base polymer.

In some embodiments, used as the cationic monomer is DADMAC, amount of which is 5 mol % to 25 mol % of the acrylamide type base polymer.

In a further embodiment, used as the cationic monomer is DADMAC, amount of which is 8 mol % to 20 mol % of the acrylamide type base polymer.

In some embodiments of the cationic acrylamide type base polymer, used as the acrylamide type monomer is acrylamide, and used as the cationic monomer is DADMAC, amount of which is 5 mol % to 25 mol % of the acrylamide type base polymer.

In some embodiments of the cationic acrylamide type base polymer, used as the acrylamide type monomer is acrylamide, and used as the cationic monomer is DADMAC, amount of which is 8 mol % to 20 mol % of the acrylamide type base polymer.

Anionic Monomer

An anionic monomer will be used herein in circumstances of forming an anionic or amphoteric acrylamide type base polymer by copolymerization. In the invention, the anionic monomer may be an α,β-unsaturated carboxylic acid comprising 3 to 7 carbon atoms or a salt thereof.

Examples of the anionic monomer suitable for the invention include but are not limited to: acrylic acid, methacrylic acid, itaconic acid, maleic acid, maleic anhydride, and salts of these acids, or combinations of two or more thereof. That is to say, in the acrylamide type base polymer, if an anionic monomer is present, more than one (for example, two, three, or more) anionic monomer may be present based on need.

In some specific embodiments, used as the anionic monomer is acrylic acid or methacrylic acid.

Generally, If an anionic monomer is present, i.e. in the cases of an amphoteric or anionic acrylamide type base polymer, the amount of said anionic monomer is usually no more than 30 mol %, for example, 1 mol %-10 mol % of the base polymer.

In some embodiments, used as the anionic monomer is acrylic acid, amount of which is 1 mol % to 10 mol % of the acrylamide type base polymer.

In a further embodiment, used as the anionic monomer is acrylic acid, amount of which is 2 mol % to 8 mol % of the acrylamide type base polymer.

In the case of an amphoteric acrylamide type base polymer, both a cationic monomer and an anionic monomer are present. In the invention, there is usually no limitation to the ratio between the cationic monomer and the anionic monomer, as long as a stable polymer can be obtained. It is convenient if the molar number of the cationic monomer is more than the molar number of the anionic monomer.

Conveniently, the total amount of the cationic monomer and the anionic monomer accounts for at least 9 mol %, for example, at least 10 mol % of the base polymer, but the amount of cationic monomer usually does not exceed 50 mol %, for example, does not exceed 25 mol % of the base polymer.

In some embodiments about the amphoteric acrylamide type the base polymer, the total amount of cationic monomer and anionic monomer accounts for 9 mol % to 20 mol % of the base polymer, and the molar number of the cationic monomer is more than the molar number of the anionic monomer.

In some embodiments about the amphoteric acrylamide type the base polymer, the total amount of the cationic monomer and anionic monomer accounts for 9 mol % to 20 mol % of the base polymer, and the molar number of the cationic monomer is more than the molar number of the anionic monomer, wherein the cationic monomer is DADMAC, and the anionic monomer is acrylic acid.

The amount of the cationic monomer in the acrylamide type base polymer corresponds to the amount of said cationic monomer in the dialdehyde modified acrylamide type polymer. It should be noted that in the dialdehyde modified acrylamide type polymer according to the invention, the amount of the cationic monomer is significantly higher than the amount of the cationic monomer in the similar products available in the market. In addition, a skilled artisan has already found that although the increase of the number of the cationic monomer (i.e. the charges of the cations) will improve the stability, but with the increase of the charges of the cations, the strengthening performance of the dialdehyde modified acrylamide type polymer (for example, increasing the dry strength and the wet strength, and the like) significantly drops. However, the dialdehyde modified acrylamide type polymer of the invention or prepared according to invention still has satisfactory stability and strengthening performance while having high cation charges.

Cross Linking Agent

A cross linking agent is used in the step of forming an acrylamide type of the base polymer by copolymerization according to the invention. The cross linking agent used herein is an unsaturated monomer which has at least two (for example, two, three or four) unsaturated double bonds.

Herein, the unsaturated double bond for example, is C═C bond, i.e. alkenyl; or may be C═O, i.e. carbonyl.

In some embodiments, used as the cross linking agent is a monomer/compound having at least two (for example, two, three or four) vinyls. For example, in some embodiments, used as the cross linking agent is an amino or amido containing compound having at least two (for example, two, three or four) vinyls.

The cross linking agents suitable for the invention include, for example: triallylamine, diallylamine, methylenediacrylamide, methylene di(meth)acrylic acid or an ester thereof, diglycol di(meth)acrylic acid or an ester thereof, or glycol di(meth)acrylic acid or an ester thereof.

Herein, “(methyl)acrylic acid” means to include both acrylic acid and methacrylic acid.

In some embodiments, used as the cross linking agent is triallylamine.

In some embodiments, used as the cross linking agent is diallylamine.

In some embodiments, used as the cross linking agent is methylene diallylamine.

In the invention, the amount of the cross linking agent is very low, which only accounts for 0.00001 mol %-0.1 mol %, for example, 0.0001 mol %-0.01 mol % of the acrylamide type base polymer.

In some embodiments, the amount of the cross linking agent is as low as 0.0001-0.001 mol % of the acrylamide type base polymer.

In some specific embodiments, used as the cross linking agent is triallylamine, amount of which is 0.0001-0.001 mol % of the acrylamide type base polymer.

In some specific embodiments, used as the cross linking agent is methylene diallylamine, amount of which is 0.0001-0.001 mol % of the acrylamide type base polymer.

In the invention, unless otherwise specified, the amount of the cationic monomer, the anionic monomer, and the cross linking agent are all directed to the acrylamide type base polymer.

Copolymerization and Acrylamide Type Base Polymer

The copolymerization of the acrylamide type of the base polymer formed in step (a) can be conducted according to copolymerization method of the known acrylamide type polymers, for example, the known method in US2010/0089542 A1. For example, as shown in Example 1 of US2010/0089542 A1, the general procedure of the copolymerization is: under proper temperature conditions, dripping an initiator to the aqueous phase comprising various monomers, thereby the various monomers gradually polymerize. A skilled artisan knows well how to select the proper reaction temperature, reaction media and other suitable additives such as catalysts according to the monomers for the copolymerization.

The weight average molecular weight of the acrylamide type base polymer can be reflected by measuring its RSV (reduced specific viscosity). RSV value and the method for measuring it are well known in the art.

In the invention, the RSV value of the acrylamide type base polymer sample is measure according to the following manner:

2.5 g sample is precisely weighed and dissolved in 50 ml 2 mol/L NaNO₃ solution. After dissolved thoroughly, it is precisely volumed in a 100 ml volumetric flask. Subsequently, 3 ml solution is precisely weighed and transferred into a viscometer. The viscometer is placed upright in a 30° C. constant temperature water bath. Solution is transferred with a rubber suction bulb to the upper mark on the bulb portion of the viscometer. The time that the solution takes from the upper mark to the lower mark on the bulb portion is measured as t(1). The above solution is diluted two times and the time taken is measured again using the aforesaid method as t(2). The same method is used to measure the time taken for 1 mol/L NaNO₃ solution as to. The following equation is used to calculate the corresponding RSV(1) and RSV(2), i.e.

RSV=(1/c)[(t/tₒ)−1]

wherein c is the concentration of the sample in the solution (weight percentage),

t is the tame taken for the solution from the upper mark to the lower mark of the bulb portion;

finally, using RSV as the y-axis and the concentration as the x-axis, the aforesaid samples 1 and 2 are plotted to yield a line. The RSV where the concentration is extrapolated to 0 is the RSV value of said sample.

Based on the specific measurement method employed, certain correlation may be established between the RSV value measured and its weight average molecular weight.

According to the invention, the RSV value of the acrylamide type the base polymer obtained in step (a) is usually no more than 0.2 dl/g. That is to say, according to the invention, the weight average molecular weight of the acrylamide type the base polymer obtained in step (a) is no more than 20,000 g/mol.

Typically, according to the invention, the RSV value of the acrylamide type the base polymer obtained in step (a) is 0.08-0.16 dl/g. That is to say, the weight average molecular weight of said acrylamide type the base polymer is typically 6000-15000 g/mol.

In addition, said acrylamide type base polymer may be cationic, anionic or amphoteric, for example, may be cationic or amphoteric.

In some embodiments, triallylamine is used as the cross linking agent for preparing the amphoteric acrylamide type base polymer. In some embodiments, prepared is an amphoteric acrylamide type base polymer with a weight average molecular weight of no more than 20,000 g/mol, for example, 6000-15000 g/mol, wherein the cationic monomer and anionic monomer may be those exemplified above. In some specific embodiments, the cationic monomer is DADMAC, and the anionic monomer is acrylic acid.

In the case of the amphoteric acrylamide type base polymer, the exemplary amounts of the cationic monomer and the anionic monomer described in the “cationic monomer” and the “anionic monomer” section above, respectively, are applicable. For example, the total amount of the cationic monomer and the anionic monomer accounts for more than 9 mol %, for example, at least 10 mol % of the base polymer more, and the amount of the cationic monomer does not exceed 50 mol % of the base polymer, anionic monomer usually does not exceed 25 mol % of the base polymer. According to some embodiments of the invention, in the case of the amphoteric acrylamide type base polymer, the molar number of the cationic monomer should be more than the molar number of the anionic monomer.

In a further specific embodiment, the cationic monomer, the anionic monomer, the acrylamide and the cross linking agent are used to prepare an amphoteric acrylamide type base polymer with a weight average molecular weight of no more than 20,000 g/mol, for example, 6000-15000 g/mol, the cationic monomer of 5 mol %-25 mol %, for example, 8 mol %-20 mol % of DADMAC, and the anionic monomer of 1 mol %-10 mol %, for example, 2 mol %-8 mol % of acrylic acid.

In some embodiments, triallylamine or methylenediacrylamide is used as the cross linking agent to prepare the cationic acrylamide type base polymer. In some embodiments, prepared is a cationic acrylamide type base polymer with a weight average molecular weight of no more than 20,000 g/mol, for example, 6000-15000 g/mol, wherein the cationic monomer may be those exemplified above. In some specific embodiments, the cationic monomer is DADMAC.

In the case of the cationic acrylamide type base polymer, it is applicable as mentioned above that the amount of the cationic monomer may be at least 9 mol % of the base polymer, does not exceed 50 mol % of the base polymer. According to some embodiments of the invention, typically the amount of the cationic monomer is 10 mol %-25 mol %, and most typically is 10 mol %-18 mol %.

In a further specific embodiment, the cationic monomer, the acrylamide and the cross linking agent are used to prepare a cationic acrylamide type base polymer with a weight average molecular weight of no more than 20,000 g/mol, for example, 6000-15000 g/mol, and the cationic monomer of 5 mol %-25 mol %, for example, 8 mol %-20 mol % of DADMAC.

The acrylamide type base polymer prepared according to the method of the invention usually has a Brookfield viscosity of no more than 2000 cps, typically in the range of 200 to 2000 cps, under the conditions of 35-45 wt % concentration. Similarly, as mentioned above, by measuring the RSV of the acrylamide type base polymer obtained, the RSV value of a acrylamide type base polymer with a concentration of 0.05 wt % in 1 mol/L NaNO₃ is generally less than 0.2 dl/g, typically in the range of 0.08-0.16 dl/g. The measurement of the Brookfield viscosity and RSV as mentioned above is conducted according to know methods in the art.

Dialdehyde Modification and Dialdehyde Modified Acrylamide Type Polymer

According to the invention, the step (b) is the step of dialdehyde modification, which can be conducted according to the dialdehyde modification step described in literature (for example, U.S. Pat. No. 7,901,543 B2, to Nalco Co.). Dialdehyde suitable for the invention may be selected from glyoxal, malondialdehyde, succinic aldehyde and glutaraldehyde. Typically, used as the dialdehyde is glyoxal.

In the dialdehyde modification reaction of step (b), the dialdehyde reacts (cross links) with the acrylamide type base polymer obtained in step a), especially the amino group. Said reaction requires a pH value of no less than 5, usually no more than 10, and a reaction temperature of no less than 20° C., usually no more than 100° C. Under such conditions, the dialdehyde and the amino groups in the acrylamide type base polymer keep reacting, accompanied by the continuous increase of the viscosity of the solution. A skilled artisan knows well how to select the proper reaction conditions, such as temperature, reaction media and other suitable additives such as catalysts, and the like, according to the raw materials used.

It should be noted that, in the “cross linking reaction” between the dialdehyde and the acrylamide type base polymer, especially between the dialdehyde and the amino group in it, the dialdehyde is also considered as a “cross linking agent” in said reaction. In order to distinguish them, in the invention, the cross linking agent mentioned means the monomer or compound serving the cross linking function used during the synthesis of the acrylamide type base polymer (i.e., before the dialdehyde modification), especially the unsaturated monomer and compound having at least two (for example, two, three or four) unsaturated double bonds mentioned above in “cross linking agent”.

In the dialdehyde modified acrylamide type polymer of the invention, the molar ratio between the dialdehyde and the acrylamide type monomer (the G/A ratio) may be 0.01-1, for example, is 0.2-0.8, and further for example, is 0.3-0.5.

In a specific embodiment, the dialdehyde modified acrylamide type polymer is obtained by reacting glyoxal with an amphoteric acrylamide type polymer in a G/A ratio of 0.2-0.8, wherein the amphoteric acrylamide type base polymer is formed by the copolymerization of an acrylamide, a cationic monomer, an anionic monomer and a cross linking agent;

wherein the amphoteric acrylamide type base polymer has a weight average molecular weight of no more than 20,000 g/mol, for example, an amphoteric acrylamide type base polymer of 6000-15000 g/mol, the amount of the cationic monomer is 5 mol %-25 mol %, for example, 8 mol %-20 mol %, and the amount of the anionic monomer is 1 mol %-10 mol %, for example, 2 mol %-8 mol %, and wherein the cross linking agent is an unsaturated monomer having two or three vinyls.

In a further embodiment, the dialdehyde modified acrylamide type polymer is obtained by reacting glyoxal with an amphoteric acrylamide type polymer in a G/A ratio of 0.3-0.5, wherein the amphoteric acrylamide type base polymer is formed by copolymerization of an acrylamide, a cationic monomer, an anionic monomer and a cross linking agent; wherein the amphoteric acrylamide type base polymer has a weight average molecular weight of no more than 20,000 g/mol, for example, an amphoteric acrylamide type base polymer of 6000-15000 g/mol, the cationic monomer is 5 mol %-25 mol %, for example, 8 mol %-20 mol % of DADMAC, and the anionic monomer is 1 mol %-10 mol %, for example, 2 mol %-8 mol % of acrylic acid, and

wherein the cross linking agent is triallylamine or methylenediacrylamide.

In a specific embodiment, the dialdehyde modified acrylamide type polymer is formed by reacting glyoxal with a cationic acrylamide type polymer in a G/A ratio of 0.2-0.8 the G/A ratio, wherein the cationic acrylamide type base polymer is formed by the copolymerization of an acrylamide, a cationic monomer and a cross linking agent; wherein the cationic acrylamide type base polymer has a weight average molecular weight of no more than 20,000 g/mol, for example, an amphoteric acrylamide type base polymer of 6000-15000 g/mol, and the amount of the cationic monomer is 5 mol %-25 mol %, for example, 8 mol %-20 mol %, and wherein the cross linking agent is an unsaturated monomer having two or three vinyls.

In a further embodiment, the dialdehyde modified acrylamide type polymer is obtained by reacting glyoxal with a cationic acrylamide type polymer in a G/A ratio of 0.3-0.5, wherein the cationic acrylamide type base polymer is formed by copolymerization of an acrylamide, a cationic monomer and a cross linking agent; wherein the cationic acrylamide type base polymer has a weight average molecular weight of no more than 20,000 g/mol, for example, a cationic acrylamide type base polymer of 6000-15000 g/mol, and the cationic monomer is 5 mol %-25 mol %, for example, 8 mol %-20 mol % of DADMAC, and wherein the cross linking agent is triallylamine or methylenediacrylamide.

It should be understood that depending on the G/A ratio employed, the weight average molecular weight of the dialdehyde modified acrylamide type polymer of the invention can vary in the range of 50 0000-300 0000 g/mol.

Conveniently, if the solid content of the product is 10%, and the G/A ratio is 0.4, according to the invention, the dialdehyde modified acrylamide type polymer has a viscosity of no more than 30 cps. Herein, the typical target viscosity of the dialdehyde modified acrylamide type polymer is 14-16 cps, for example, 15 cps.

Under such conditions, the inventor has found that the shelf life of the eventual product can be further extended. That is, the stability of the product is further improved.

The amount of the cationic monomer and the anionic monomer in the final dialdehyde modified acrylamide type polymer corresponds to their amounts in used in the acrylamide type base polymer.

As mentioned above, the sum of the numbers of the cationic monomers and the anionic monomers in the invention or the number of the cationic monomer itself (i.e., charge) is higher than the number of charged in the conventionally used dialdehyde modified acrylamide type polymer. Even so, the dialdehyde modified acrylamide type polymer of the invention does not exhibit stability issues as conventionally assumed, but as mentioned in the beginning of this article, the dialdehyde modified acrylamide type polymer of the invention not only has improved stability but also can retain excellent functionality, for example, performance of increased dry strength and the like, compared to the commercial available glyoxalated acrylamide copolymers.

Method for Using the Dialdehyde Modified Acrylamide Type Polymer in the Paper Making Process

The dialdehyde modified acrylamide type polymer according to the invention can be used in a paper making process. In particular, the dialdehyde modified acrylamide type polymer according to the invention can be used as a paper strengthening agent or dehydrating agent in the paper making process.

The dialdehyde modified acrylamide type polymer according to the invention can be used as a traditional paper strengthening agent and dehydrating agent, for example, used as a commercially available glyoxal modified polyacrylamide. For example, the dialdehyde modified acrylamide type polymer of the invention can be applied to a wet portion for a wet additive, including a thick stock and a thin stock.

Moreover, since said polymer can also serve as a press adjuvant, there is no need to add it into the wet portion. It may be attempted to choose to add it after the formation of the sheet and immediately before the press portion. For example the polymer can be sprayed onto the wet portion before entering the press portion. The dialdehyde modified acrylamide type polymer of the invention may also be used in combination with other paper making additives such as a wet portion additive. These wet portion additives, for example, include a retention aid, an adhesive, starch, and the like.

The amount of the dialdehyde modified acrylamide type polymer according to the invention can be chosen according to the specific pulp system and the eventually prepared paper product type. Usually, the amount of the dialdehyde modified acrylamide type polymer according to the invention may be 10 kg-80 kg/t (dry weight of the pulp).

The aforesaid description of the invention can be better understood in reference to the following examples. These examples are intended to explain rather than limit the scope of the invention.

### EXAMPLES

### Synthesis of High Cationic Charge or Amphoteric Dialdehyde Modified Acrylamide Type Polymers Using a Cross Linking Agent

Acrylamide Type Base Polymer Preparative Example 1:

To a 2 L three necked bottle equipped with heating and condensation pipes, 146.1 g soft water, 16.25 g 48% sodium hydroxide, 26.27 g 75% phosphoric acid, 7.6 g sodium formate, 0.1 g ethylenediamine tetraacetic acid and 161 g diallyldimethylammonium chloride (62% concentration) were added. After the resultant solution was heated to 100° C., an initiator comprising 4.4 g ammonium persulfate (APS) and 13.2 g soft water was started to be added dropwise, which took 130 minutes to finish. After 2 minutes into the addition of the initiator, a mixed solution comprising 625 g 50% acrylamide and 0.05 g triallylamine was started to be added, which took 120 minutes to finish. After the conclusion of the addition of the initiator, the temperature was kept at 100° C. After 2 hours, the reaction was completed to obtain an acrylamide type base polymer 1 having a solid content of about 41% and viscosity of about 230 cps, which has a weight average molecular weight exhibited by RSV of about 0.12 dl/g, wherein the cationic monomer concentration was 12 mol %.

Acrylamide Type Base Polymer Preparative Example 2:

To a 2 L three necked bottle equipped with heating and condensation pipes, 146.1 g soft water, 16.25 g 48% sodium hydroxide, 26.27 g 75% phosphoric acid, 7.6 g sodium formate, 0.1 g ethylenediamine tetraacetic acid and 161 g diallyldimethylammonium chloride (62% concentration) were added. After the resultant solution was heated to 100° C., an initiator comprising 4.4 g ammonium persulfate (APS) and 13.2 g soft water was started to be added dropwise, which took 130 minutes to finish. After 2 minutes into the addition of the initiator, a mixed solution comprising 625 g 50% acrylamide and 0.1 g methylenediacrylamide was started to be added, which took 120 minutes to finish. After the conclusion of the addition of the initiator, the temperature was kept at 100° C. After 2 hours, the reaction was completed to obtain an acrylamide type base polymer 2 having a solid content of about 41% and viscosity of about 230 cps, which has an RSV of about 0.1 dl/g, wherein the cationic monomer concentration was 12 mol %.

Acrylamide Type Base Polymer Preparative Example 3:

To a 2 L three necked bottle equipped with heating and condensation pipes, 203.76 g soft water, 18.06 g 48% sodium hydroxide, 26.27 g 75% phosphoric acid, 7.6 g sodium formate, 0.1 g ethylenediamine tetraacetic acid and 125 g diallyldimethylammonium chloride (62% concentration) were added. After the resultant solution was heated to 100° C., an initiator comprising 4.4 g ammonium persulfate (APS) and 13.2 g soft water was started to be added dropwise, which took 130 minutes to finish. After 2 minutes into the addition of the initiator, a mixed solution comprising 585 g 50% acrylamide, 16.6 g acrylic acid and 0.01 g triallylamine was started to be added, which took 120 minutes to finish. After the conclusion of the addition of the initiator, the temperature was kept at 100° C. After 2 hours, the reaction was completed to obtain an acrylamide type base polymer 3 having a solid content of about 41% and viscosity of about 1300 cps, which has an RSV of about 0.17 dl/g, wherein the cationic monomer concentration was 9.5 mol % and the anionic monomer was 4.5 mol %.

Synthesis of Cationic Dialdehyde Modified Acrylamide Type Polymers without Using a Cross Linking Agent

Preparation of the Comparative Acrylamide Type Base Polymer 1

To a 2 L three necked bottle equipped with heating and condensation pipes, 124.98 g soft water, 16.25 g 48% sodium hydroxide, 26.27 g 75% phosphoric acid, 7.6 g sodium formate, 0.1 g ethylenediamine tetraacetic acid and 63.8 g diallyldimethylammonium chloride (62% concentration) were added. After the resultant solution was heated to 100° C., an initiator comprising 4.4 g ammonium persulfate (APS) and 13.2 g soft water was started to be added dropwise, which took 130 minutes to finish. After 2 minutes into the addition of the initiator, a mixed solution comprising 743.4 g 50% acrylamide was started to be added, which took 120 minutes to finish. After the conclusion of the addition of the initiator, the temperature was kept at 100° C. After 2 hours, the reaction was completed to obtain a comparative acrylamide type base polymer 1 having a solid content of about 41% and viscosity of about 1100 cps, which has an RSV of about 0.16, wherein the cationic monomer concentration was 5 mol %.

Preparation of the Comparative Acrylamide Type Base Polymer 1

To a 2 L three necked bottle equipped with heating and condensation pipes, 146.1 g soft water, 16.25 g 48% sodium hydroxide, 26.27 g 75% phosphoric acid, 7.6 g sodium formate, 0.1 g ethylenediamine tetraacetic acid and 161 g diallyldimethylammonium chloride (62% concentration) were added. After the resultant solution was heated to 100° C., an initiator comprising 4.4 g ammonium persulfate (APS) and 13.2 g soft water was started to be added dropwise, which took 130 minutes to finish. After 2 minutes into the addition of the initiator, a mixed solution comprising 625 g 50% acrylamide was started to be added, which took 120 minutes to finish. After the conclusion of the addition of the initiator, the temperature was kept at 100° C. After 2 hours, the reaction was completed to obtain a comparative acrylamide type base polymer 2 having a solid content of about 41% and viscosity of about 870 cps, which has an RSV of about 0.14, wherein the cationic monomer concentration was 12 mol %.

### Dialdehyde Modification of the Acrylamide Type Base Polymers Using Dialdehyde

### Example 1

To a 2 L glass instrument, 752.3 g soft water and 194.2 g aforesaid acrylamide type base polymer 1 were added, respectively, and the pH of solution was adjusted to about 9 with 0.3 g 48% sodium hydroxide. 49.9 g 40% glyoxal solution was added, and the pH of the solution was adjusted to about 8 with 3 g 5% sodium hydroxide. The reaction was conducted at room temperature, and the viscosity of the reaction solution was continuously monitored with a viscometer. At the start, the viscosity of the reactants was about 4-5 cps. After the viscosity of the reactants reached 16 cps, 50% sulfate acid was added dropwise to adjust the pH of the products to 3, yielding a product with a solid content of 10% and G/A=0.4, which was designated as the GPAM product 1.

### Example 2

To a 2 L glass instrument, 752.3 g soft water and 194.2 g aforesaid acrylamide type base polymer 2 were added, respectively, and the pH of solution was adjusted to about 9 with 0.26 g 48% sodium hydroxide. 81.9 g 40% glyoxal solution was added, and the pH of the solution was adjusted to about 8 with 3 g 5% sodium hydroxide. The reaction was conducted at room temperature, and the viscosity of the reaction solution was continuously monitored with a viscometer. At the start, the viscosity of the reactants was about 4-5 cps. After the viscosity of the reactants reached 16 cps, 50% sulfate acid was added dropwise to adjust the pH of the products to 3, yielding a product with a solid content of 10% and G/A=0.4, which was designated as the GPAM product 2.

### Example 3

To a 2 L glass instrument, 750.8 g soft water and 194.2 g aforesaid acrylamide type base polymer 3 were added, respectively, and the pH of solution was adjusted to about 9 with 0.4 g 48% sodium hydroxide. 49.9 g 40% glyoxal solution was added, and the pH of the solution was adjusted to about 8 with 3.2 g 5% sodium hydroxide. The reaction was conducted at room temperature, and the viscosity of the reaction solution was continuously monitored with a viscometer. At the start, the viscosity of the reactants was about 5-6 cps. After the viscosity of the reactants reached 16 cps, 50% sulfate acid was added dropwise to adjust the pH of the products to 3, yielding a product with a solid content of 10% and G/A=0.4, which was designated as the GPAM product 3.

### Comparative Example 1

To a 2 L glass instrument, 751.84 g soft water and 188.3 g comparative acrylamide type base polymer 1 were added, respectively, and the pH of solution was adjusted to about 9 with 0.26 g 48% sodium hydroxide. 56.4 g 40% glyoxal solution was added, and the pH of the solution was adjusted to about 8 with 3.2 g 5% sodium hydroxide. The reaction was conducted at room temperature, and the viscosity of the reaction solution was continuously monitored with a viscometer. At the start, the viscosity of the reactants was about 5-6 cps. After the viscosity of the reactants reached 16 cps, 50% sulfate acid was added dropwise to adjust the pH of the products to 3, yielding a product with a solid content of 10% and G/A=0.4, which was designated as the Comparative GPAM product 1.

### Comparative Example 2

To a 2 L glass instrument, 752.3 g soft water and 194.2 g comparative acrylamide type base polymer 2 were added, respectively, and the pH of solution was adjusted to about 9 with 0.3 g 48% sodium hydroxide. 49.9 g 40% glyoxal solution was added, and the pH of the solution was adjusted to about 8 with 3 g 5% sodium hydroxide. The reaction was conducted at room temperature, and the viscosity of the reaction solution was continuously monitored with a viscometer. At the start, the viscosity of the reactants was about 4-5 cps. After the viscosity of the reactants reached 16 cps, 50% sulfate acid was added dropwise to adjust the pH of the products to 3, yielding a product with a solid content of 10% and G/A=0.4, which was designated as the Comparative GPAM product 2.

Test Methods for Samples

1. Stability Test (35° C.)

The stability test was conducted as follows: the test sample was kept at a constant temperature in a 35° C. oven. Daily, a sample was taken to measure its viscosity with the temperature dropped to the room temperature (25° C.), until the sample gelatinized. Their viscosity was measured using a Brookfield viscometer (1# Spindle, 60 rpm, 25° C.).

Description of the viscosity measurement: Brookfield Programmable LVDV-II+ viscometer, Brookfield Engineering Laboratories, Inc, Middleboro, Mass., was employed in this experiment.

0-100 cps, measured by Spindle 1 at 60 rpm

100-1000 cps, measured by Spindle 2 at 30 rpm

1000-10000 cps, measured by Spindle 3 at 12 rpm

2. Tests for Sheet Properties

The aforesaid high charge or amphoteric glyoxylated polyacrylamide copolymers were used for the tests for the dry strength, wet strength and sheet retention of the hand sheets.

Description of the paper making process: The pulp slurry (thick stock) is obtained directly from a paper mill, the primary component of which is a mixture of the American Old Corrugated Container (AOCC) and China Old Corrugated Container (COCC) with an electrical conductivity of 3.0 ms/cm. Sheet-making is performed after the thick stock is diluted with tape water to a concentration of about 0.7%. The electrical conductivity is controlled at about 3 ms/cm during the whole sheet-making process.

Semi-automatic Tappi standard sheet-making machine, provided by FRANK-PTI Co., is used as sheet-making machine. The specific test method is described in T205 Introduction sp-02. To the diluted pulp, 15 kg/ton of starch, the aforesaid GPAM products (30 kg/ton), dual retention aid (0.2 kg/ton of Nalco 61067 and 2 kg/ton of bentonite) are added successively at a rotation speed of 800 rpm in an addition interval of 15 seconds.

The pulp added with the agents is poured into a forming cylinder of paper-making machine and undergoes filtering and forming. Afterwards, the forming cylinder is opened, and a bibulous paper is taken to cover the wet paper sheet which is then covered with a flat clamp to remove part of water. Then the paper sample is transferred to a new bibulous paper which is then covered with stainless steel clamp, onto which a bibulous paper is covered again, the wet paper sample is thus accumulated. When 5 to 10 paper samples are accumulated, they are provided into a special press machine to perform a two-section pressing, further removing water from paper.

The pressed paper is transferred to a constant temperature and humidity lab (50% humidity at 23° C.), and every single paper sample is placed into a special metal ring. The metal rings are piled up and a heavy object is placed onto the metal ring where the paper sample lies on. After air dried for 24 hours, the paper sample can be peeled successively from stainless steel clamp for corresponding test.

Description of the Test Method for Dry Tensile Index (Dry Strength):

Tensile index refers to the maximum force that paper or paperboard can withstand at a specified condition. The specification is described in Tappi 494 om-06 standard. A L&W Horizontal Tensile Tester is used in the experiment. The pressure of the tester is set to 2 kg. The cut paper sample is placed between two clamps of the tester. The tester will automatically stretch the paper sample until it is broken. The maximum tensile value shown on the display is read which is expressed as N. The dry tensile index is calculated as follows:

Y=F/(L*g)×1000

Y—tensile index, N*m/g

F—tensile force, N

L—width of the test paper sample, mm

g—paper basis weight, g/m

Description of the Test Method for the Temporary Wet Tensile Index (Temporary Wet Strength) of the Sheets:

KZW-300 Microcomputer-controlled Tensile Test Machine from Changchun paper testing machine factory is used in this experiment. A paper sample is cut out with a width of 15 mm and a length of larger than 15 cm. A sponge is provided and completely soaked in water. The cut paper sample is pressed onto the wet sponge for one second (Is) each side, and then the sample is immediately held between the two clamps of the test machine. The test is started and the strength at break is recorded, expressed as N. The equation for calculating the temporary wet tensile index is identical to the one introduced above for the dry tensile index.

Description of the Test Method for Sheet Ash:

The fiber materials for paper making or the pulp components will themselves contain a certain amount of minerals. During the paper making process, a certain amount of minerals will also be added to save the cost of the fiber materials. Therefore, the residual minerals after burning and incineration of the sheet at high temperature are called ash. The test method for the ash of the paper and paperboard is found in GB/T 463-1989. A certain amount of paper sample is precisely weighed and put into a crucible pre-burnt to constant weight, and they are transferred into a muffle furnace and burnt at 550° C. for 1.5 h. The crucible is removed and cooled in air for 5-10 min, before being transferred into a drier, cooled and weighed until constant weight. The equation for calculation is as follows:

X=(m2−m1)/m×100%;

m1: the weight of the crucible after burning, g;

m2: the weight of the crucible with ash after burning, g;

m: the dry weight of the sample, g.

Sheet Retention Test

Description of the Test Method for Sheet Retention:

The instrument is DFR04 produced by BTG. Pulp with fillers from paper mills is used, primary components of which is a mixture of NBKP, LBKP and BCTMP The protocol is to measure the first layer retention using a retention and filtration ternary system which is composed of a retention aid, a filtration aid, and a glyoxalated polyacrylamide dry strengthening agent

The samples of the above examples and comparative examples were tested according to said methods and the results are listed provided as FIG. 1.

### SUMMARY

GPAM products 1 to 3 are the dialdehyde modified acrylamide type polymer prepared according to the invention, wherein a cross linking agent has been used for the synthesis of the high charge acrylamide type base polymer. The comparative GPAM product 1 is a commercially available product, wherein no cross linking agent has been used for the synthesis of the acrylamide type base polymer and it has a low cation charge. The comparative GPAM product 2 is a product prepared by merely increasing the charges (i.e., increasing the cationic monomers) of the acrylamide type base polymer.

By comparing the data in Table 1, it is seen that the GPAM products 1 to 3 according to the invention have both the good functionality of the comparative GPAM product 1 (the commercially available product) and the good stability of the comparative GPAM product 2. That is to say, by employing the GPAM products according to the invention, the stability and shelf life of the products are greatly increased while ensuring that the dry strength, the temporary wet strength, the ash retention and the first layer retention of the sheet are no less than those of the dialdehyde modified acrylamide copolymer not employing the cross linking agent.

It should be especially noted that although the relative increase of the dry strength does not appear to increase much, however, in practice, usually the performance of the dry strength should be considered in relation to the ash. Usually, the higher the ash is, the lower the strength will be. For example, the dry strength of the GPAM product 1 and comparative GPAM product 2 is 27.3 N·m/g and 27 N·m/g, respectively, while the corresponding ash content is 12.9% and 12.1%. This indicates that if the ash content were the same, the dry strength of the GPAM product 1 would be much higher than that of the comparative GPAM product 2. As also judged by other performance, the first layer retention of the GPAM product 1 is also much better than that of the comparative GPAM product 2. Therefore, according to the invention, GPAM product 1 has a much better performance than the comparative GPAM product 2.

Therefore, the dialdehyde modified acrylamide type copolymers according to the invention has much improved stability and shelf life which is satisfactory, while still ensuring that their dry strength, temporary wet strength, ash retention and first layer retention of the sheet are no less than those of the existent non-cross linked glyoxalated acrylamide copolymers.

1. A dialdehyde modified acrylamide type polymer for paper making, which is obtained by reacting a dialdehyde with an acrylamide type base polymer, wherein the acrylamide type base polymer is formed by copolymerization of an acrylamide type monomer, a cationic monomer and/or an anionic monomer, and a cross linking agent,
wherein the total amount of the cationic monomer and anionic monomer is from 9 mol % to 50 mol %, and
wherein the cross linking agent is a monomer having at least two unsaturated double bonds.

2. The dialdehyde modified acrylamide type polymer of claim 1, wherein the amount of the cross linking agent is from 0.00001 mol % to 0.1 mol % of the acrylamide type base polymer.

3. The dialdehyde modified acrylamide type polymer of claim 1, wherein the cross linking agent is selected from triallylamine, diallylamine, methylenediacrylamide, methylene di(meth)acrylic acid or an ester thereof, diglycol di(meth)acrylic acid or an ester thereof, or glycol di(meth)acrylic acid or an ester thereof.

4. The dialdehyde modified acrylamide type polymer of claim 1, wherein the weight average molecular weight of the acrylamide type base polymer is from 6,000 to 20,000 g/mol.

5. The dialdehyde modified acrylamide type polymer of claim 1, wherein the acrylamide type base polymer is cationic or amphoteric.

6. (canceled)

7. The dialdehyde modified acrylamide type polymer of claim 1, wherein the cationic monomer is selected from diallyl-N,N-disubstituted ammonium chloride monomer, diallyldimethyl ammonium chloride, N-(3-dimethylaminopropyl)methacrylamide, N-(3-dimethylaminopropyl)acrylamide, methylacroloyloxyethyltrimethyl ammonium chloride, acroloyloxyethyltrimethylammonium chloride, methylacroloyloxyethyldimethylbenzyl ammonium chloride, acroloyloxyethyldimethylbenzyl ammonium chloride, (3-acrylamidepropyl)trimethyl ammonium chloride, methacrylamide propyltrimethylammonium chloride, 3-acrylamido-3-methylbutyltrimethylammonium chloride, 2-vinylpyridine, methacrylate 2-(dimethylamino)ethyl ester, acrylate 2-(dimethylamino) ethyl ester and glycol acrylate, and combinations thereof.

8. The dialdehyde modified acrylamide type polymer of claim 1, wherein the anionic monomer is selected from acrylic acid, methacrylic acid, itaconic acid, maleic acid, maleic anhydride, salts thereof, and combinations thereof.

9. The dialdehyde modified acrylamide type polymer of claim 1, wherein acrylamide type monomer is acrylamide, methacrylamide, and combinations thereof.

10. The dialdehyde modified acrylamide type polymer of claim 1, wherein the dialdehyde is selected from glyoxal, malondialdehyde, succinic aldehyde, glutaraldehyde, and combinations thereof.

11. The dialdehyde modified acrylamide type polymer of claim 1, wherein the molar ratio between dialdehyde and the acrylamide monomer is from 0.2 to 0.8.

12. A method for preparing a dialdehyde modified acrylamide type polymer comprising
(a) copolymerizing an acrylamide type monomer, a cationic monomer and/or anionic monomer, and a cross linking agent to form an acrylamide type base polymer, wherein the total amount of the cationic monomer and anionic monomer is from 9 mol % to 50 mol % of the acrylamide type base polymer, and
wherein the cross linking agent is a monomer having at least two vinyls; and
(b) reacting the acrylamide type base polymer with a dialdehyde to form the dialdehyde modified acrylamide type polymer.

13. The method of claim 12, wherein the cross linking agent comprises from 0.0001 mol % to 0.01 mol % of the base polymer.

14. The method of claim 12, wherein the cross linking agent is selected from triallylamine, diallylamine, methylenediacrylamide, methylene diacrylic acid or an ester thereof, or glycol diacrylate, and combinations thereof.

15. The method of claim 12, wherein the weight average molecular weight of the acrylamide type base polymer is from 6,000 to 20,000 g/mol.

16. The method of claim 12, wherein the acrylamide type base polymer is cationic or amphoteric.

17. (canceled)

18. The method of claim 12, wherein the cationic monomer is selected from diallyl-N,N-disubstituted ammonium chloride, diallyldimethylammonium chloride, N-(3-dimethylaminopropyl)methacrylamide, N-(3-dimethylaminopropyl)acrylamide, methylacroloyloxyethyltrimethylammonium chloride, acroloyloxyethyltrimethylammonium chloride, methylacroloyloxyethyldimethylbenzylammonium chloride, acroloyloxyethyldimethylbenzylammonium chloride, (3-acrylamidepropyl)trimethylammonium chloride, methacrylamidepropyltrimethylammonium chloride, 3-acrylamido-3-methylbutyltrimethylammonium chloride, 2-vinylpyridine, methacrylate-2-(dimethylamino) ethyl ester, acrylate 2-(dimethylamino) ethyl ester and glycol acrylate, and combinations thereof.

19. The method of claim 12, wherein the anionic monomer is selected from acrylic acid, methacrylic acid, itaconic acid, maleic acid, maleic anhydride and sails of these acids, and combinations thereof.

20. The method of claim 12, wherein the acrylamide type monomer is acrylamide, methacrylamide, and combinations thereof.

21. The method of claim 12, wherein the dialdehyde is selected from glyoxal, malondialdehyde, succinic aldehyde, glutaraldehyde, and combinations thereof.

22. The method of claim 12, wherein the molar ratio of the dialdehyde to the acrylamide monomer is from 0.3 to 0.5.

23-24. (canceled)

25. The dialdehyde polymer of claim 1, wherein the total amount of cationic and anionic monomer is from 10 mol % to 25 mol % of the acrylamide type base polymer.

26. The dialdehyde polymer of claim wherein the cross linking agent is a monomer having at least two vinyls.

27. (canceled)

28. The dialdehyde modified polymer of claim 11, wherein the molar ratio of dialdehyde to acrylamide monomer is from 0.3 to 0.5.

29. The method of claim 12, wherein the cross linking agent is from 0.0001 mol % to 0.001 mol % of the acrylamide type base polymer.
